(19) United States
(12) Patent Application Publication
(10) Pub. No.: US 2015/0314504 A1
(43) Pub. Date: Nov. 5, 2015

(54) METHOD FOR PRODUCING ROLLER FOR OFFICE AUTOMATION EQUIPMENT

(71) Applicant: SUMITOMO ELECTRIC FINE POLYMER, INC., Sennan-gun, Osaka (JP)

(72) Inventors: Naoki ONMORI, Osaka (JP); Yoshitaka IKEDA, Osaka (JP); Kazuhiro KIZAWA, Osaka (JP)

(21) Appl. No.: 14/649,558

(22) PCT Filed: Jul. 22, 2014
(86) PCT No.: PCT/JP2014/069316

§ 371 Date: Jun. 4, 2015

(30) Foreign Application Priority Data
Aug. 9, 2013 (JP) 2013-166172

(51) Int. Cl. B29C 45/16; B65H 29/20; F16C 13/00; B29C 45/17; B29C 35/02

(52) U.S. Cl. CPC B29C 45/1671; B29C 45/1701; B29C 45/1643; B29C 35/02; F16C 13/00; B65H 29/20; B29L 2031/324

(57) ABSTRACT

Provided is a method for producing a roller for OA equipment, with which a roller that degrades the quality of an image is not easily produced even in the case of using a fluororesin tube stored in a folded state. The method includes a close-contact step of inserting a fluororesin tube into a cylindrical mold, ensuring airtightness between the tube and an inner surface of the cylindrical mold, and subsequently performing deaeration to bring the tube into close contact with the inner surface of the cylindrical mold; a primer layer-forming step of applying an adhesive onto an inner surface of the tube that is brought into close contact with the inner surface of the cylindrical mold to form a primer layer; and a rubber layer-forming step of, after the formation of the primer layer, inserting a core bar into the cylindrical mold along a central axis of the cylindrical mold, injecting a rubber material into a gap formed between the inserted core bar and the tube, and subsequently vulcanizing the rubber material to form a rubber layer. The cylindrical mold and the tube used in the method satisfy a condition that a difference between an inner diameter of the cylindrical mold and an outer diameter of the tube is 3% to 10% of the inner diameter of the cylindrical mold.

### TECHNICAL FIELD

The present invention relates to a method for producing a roller for office automation (OA) equipment, the roller being used as a pressure roller, a fixing roller, or the like in OA equipment such as a copy machine.

### BACKGROUND ART

In general, a pressure roller, a fixing roller, and the like used in OA equipment are rollers obtained by forming a rubber layer functioning as an elastic layer on an outer circumference of a core bar, and further forming a surface layer on the rubber layer for the purpose of providing release properties of a toner or the like, the surface layer being composed of a fluororesin such as a tetrafluoroethylene-perfluoroalkylvinylether resin (PFA), a polytetrafluoroethylene resin (PTFE), or a fluorinated ethylene-propylene resin (FEP). Furthermore, in order to enhance the adhesiveness between the surface layer composed of a fluororesin and the rubber layer, a primer layer may be formed between the two layers.

In order to form a surface layer composed of a fluororesin and having good characteristics, baking at a high temperature of 400° C. or higher is necessary. However, since heat resistance of the rubber layer is lower than that of the fluororesin layer, the rubber layer is often thermally degraded in such a roller produced by the method in which the surface layer is formed after the formation of the rubber layer. Accordingly, a method including forming a fluororesin layer on an inner surface of a cylindrical mold, subsequently injecting a rubber material between the fluororesin layer and a core bar, and conducting vulcanization to form a rubber layer is employed as a method for producing a roller.

For example, PTL 1 discloses a production method including a step of coating an inner surface of a cylindrical mold with a fluororesin powder and baking the fluororesin powder to form a fluororesin layer, a step of performing an inner surface treatment on the inner surface of the fluororesin layer and applying a primer onto the inner surface, and a step of subsequently inserting a core bar into the cylindrical mold along a central axis of the cylindrical mold, injecting a rubber material between the core bar and the fluororesin layer coated with the primer, and vulcanizing the rubber material to form a rubber layer. This method is widely used in the production of rollers.

However, the above method has problems in that, for example, since a fluororesin suitable for powder coating is used in this method, electrical conductivity cannot be provided to the resulting fluororesin layer, and the maintenance of the mold must be frequently performed. Accordingly, a method in which a surface layer is formed by using a fluororesin tube has also been developed recently.

For example, PTL 2 discloses a method including inserting a fluororesin tube into a cylindrical mold, performing deaeration between the tube and an inner surface of the mold to bring the tube into close contact with the inner surface of the cylindrical mold, forming a primer layer on the inner surface of the tube, subsequently inserting a core bar into the mold along a central axis of the mold, injecting a rubber material between the core bar and the tube, and subsequently vulcanizing the rubber material to form a rubber layer.

### CITATION LIST

### Patent Literature

PTL 1: Japanese Patent No. 3833401
PTL 2: Japanese Unexamined Patent Application Publication No. 4-131227

### SUMMARY OF INVENTION

### Technical Problem

However, such a fluororesin tube inserted into a cylindrical mold is often stored in a folded state. In this case, wrinkles generated on the tube due to the storage, in particular, wrinkles due to the folds easily remain on the tube after close contact with the mold because, according to the above method, the fluororesin tube stored in a folded state is inserted into a cylindrical mold, and deaeration is then performed to bring the tube into close contact with the inner surface of the mold. When a roller is produced by forming a primer layer and a rubber layer in the state where such wrinkles remain on the surface layer, a problem in terms of smoothness of the surface easily occurs. The use of the resulting roller makes it difficult to obtain high-quality images.

An object of the present invention is to provide a method for producing a roller for OA equipment, the method including the steps of inserting a fluororesin tube into a cylindrical mold, performing deaeration between the tube and an inner surface of the mold to bring the tube into close contact with the inner surface of the cylindrical mold, forming a primer layer on an inner surface of the tube that has been brought into close contact with the inner surface of the cylindrical mold, subsequently inserting a core bar into the mold along a central axis of the mold, injecting a rubber material between the core bar and the tube, and subsequently vulcanizing the rubber material to form a rubber layer, the method being capable of providing a roller having a good surface smoothness and producing a roller that stably provides high-quality images even in the case of using a fluororesin tube stored in a folded state.

### Solution to Problem

An embodiment of the present invention provides

a method for producing a roller for OA equipment, the roller including a core bar, a rubber layer formed on the core bar, and a fluororesin surface layer formed on the rubber layer, the method including

a close-contact step of inserting a fluororesin tube into a cylindrical mold, ensuring airtightness between the tube and an inner surface of the cylindrical mold, and subsequently performing deaeration to bring the tube into close contact with the inner surface of the cylindrical mold;

a primer layer-forming step of applying a primer onto an inner surface of the tube that is brought into close contact with the inner surface of the cylindrical mold to form a primer layer; and

a rubber layer-forming step of, after the formation of the primer layer, inserting a core bar into the cylindrical mold along a central axis of the cylindrical mold, injecting a rubber material into a gap between the inserted core bar and the tube, and subsequently vulcanizing the rubber material to form a rubber layer,

in which a difference between an inner diameter of the cylindrical mold and an outer diameter of the tube is 3% to 10% of the inner diameter of the cylindrical mold.

Another embodiment of the present invention provides a roller for OA equipment, the roller being produced by the method for producing a roller for OA equipment.

### Advantageous Effects of Invention

The present invention provides a method for producing a roller for OA equipment, the method including a step of bringing a fluororesin tube into close contact with an inner surface of a cylindrical mold, in which the fluororesin tube functions as a surface layer. According to the present invention, even when a fluororesin tube stored in a folded state is used as the fluororesin tube, surface smoothness of the resulting roller is not degraded, and a roller that stably provides high-quality images can be produced. A roller for OA equipment produced by this method is used as a pressure roller, a fixing roller, or the like, and is a high-quality roller that stably provides high-quality images.

### BRIEF DESCRIPTION OF DRAWINGS

FIG. 1 includes schematic views showing a cylindrical mold and a tube that are used in an embodiment of the present invention.

FIG. 2 is a view illustrating a method for ensuring airtightness between a tube and an inner surface of a cylindrical mold, according to an embodiment of the present invention.

FIG. 3 is a flowchart showing a procedure of a method for producing a roller for OA equipment according to an embodiment of the present invention.

FIG. 4 includes schematic views showing a procedure of a method for producing a roller for OA equipment according to an embodiment of the present invention.

### DESCRIPTION OF EMBODIMENTS

As a result of intensive studies, the inventor of the present invention found that a high-quality roller in which wrinkles do not remain on a tube that has been in close contact with an inner surface of a mold, specifically, a roller that stably provides high-quality images can be produced by controlling the difference between an inner diameter of a cylindrical mold and an outer diameter of a fluororesin tube to a specific range, and this finding led to the completion of the present invention.

Specifically, an embodiment of the present invention provides

a method for producing a roller for OA equipment, the roller including a core bar, a rubber layer formed on the core bar, and a fluororesin surface layer formed on the rubber layer, the method including

a close-contact step of inserting a fluororesin tube into a cylindrical mold, ensuring airtightness between the tube and an inner surface of the cylindrical mold, and subsequently performing deaeration to bring the tube into close contact with the inner surface of the cylindrical mold;

a primer layer-forming step of applying a primer onto an inner surface of the tube that is brought into close contact with the inner surface of the cylindrical mold to form a primer layer; and

a rubber layer-forming step of, after the formation of the primer layer, inserting a core bar into the cylindrical mold along a central axis of the cylindrical mold, injecting a rubber material into a gap between the inserted core bar and the tube, and subsequently vulcanizing the rubber material to form a rubber layer,

in which a difference between an inner diameter of the cylindrical mold and an outer diameter of the tube is 3% to 10% of the inner diameter of the cylindrical mold.

This production method includes a close-contact step of inserting a fluororesin tube into a cylindrical mold and bringing the tube into close contact with an inner surface of the mold by deaeration. A core bar is inserted in the close-contact tube, and a rubber layer is formed in the tube, thus producing a roller including a rubber layer and a surface layer disposed on the rubber layer and formed of a fluororesin tube.

In this production method, the difference between the inner diameter of the cylindrical mold and the outer diameter of the tube is 3% or more relative to the inner diameter of the cylindrical mold. When the difference is 3% or more, wrinkles such as folds generated by the storage in a folded state are removed in the close-contact step, and a good roller that stably provides images with good quality can be produced. In contrast, when the difference is less than 3%, wrinkles of the tube easily remain even after the close-contact step, and the quality of the roller tends to decrease.

Wrinkles of the tube can be removed by expanding the tube in the radial direction (by expanding the diameter) while applying a tension to the tube. When the difference between the inner diameter of the cylindrical mold and the outer diameter of the tube is 3% or more, the diameter of the tube is sufficiently expanded in the step of bringing the tube into close contact with the inner surface of the mold by deaeration. Subsequently, a rubber material is injected and vulcanized, thereby maintaining a wrinkle-free state. As a result, wrinkles are reliably removed.

The difference between the inner diameter of the cylindrical mold and the outer diameter of the tube is 10% or less of the inner diameter of the cylindrical mold. When the difference between the inner diameter of the cylindrical mold and the outer diameter of the tube exceeds 10%, breakage of the tube may occur in the close-contact step. Therefore, the difference between the inner diameter of the cylindrical mold and the outer diameter of the tube is in the range of 3% to 10%, and preferably in the range of 4% to 8%.

Examples of the fluororesin that forms the tube functioning as a surface layer of the roller include PFA, PTFE, and FEP. These fluororesins are preferable because they have good heat resistance and good release properties. In particular, PFA tubes are preferably used because they have not only good heat resistance and good release properties but also high strengths, and easily form a surface layer having a good surface smoothness. Accordingly, a preferable embodiment of the present invention is the method for producing a roller for OA equipment according to the above embodiment, in which the fluororesin tube is a tube composed of PFA.

The rubber material forming the rubber layer of the roller is preferably a rubber having good heat resistance (heat-resistant rubber) such as silicone rubber or fluororubber. As the heat-resistant rubber, millable or liquid silicone rubber, fluororubber, or a mixture thereof is preferably used. Specific examples thereof include silicone rubbers such as dimethyl silicone rubber, fluorosilicone rubber, and methylphenyl silicone rubber; and fluororubbers such as vinylidene fluoride rubber, tetrafluoroethylene-propylene rubber, and tetrafluoroethylene-perfluoromethylvinylether rubber.

The rubber material may contain an organic microballoon. Herein, the term “organic microballoon” refers to a type of hollow microsphere, for example, a hollow spherical fine particle composed of an organic polymeric material such as a thermosetting resin, e.g., a phenolic resin; a thermoplastic resin, e.g., polyvinylidene chloride or polystyrene; or a rubber. The size (diameter) of the organic microballoon is usually several micrometers to several hundreds of micrometers, and in many cases, 5 to 200 μm.

Since organic microballoons are spherical, even when the organic microballoons are incorporated into the rubber material, stress anisotropy is not caused and a rubber layer whose hardness and heat-insulating property are not varied can be formed. Incorporation of organic microballoons is preferable because a rubber layer having excellent flexibility and good dimensional stability can be formed. In addition, since the heat-insulating property is improved, incorporation of organic microballoons is suitable for forming a roller member that requires heat insulation. Accordingly, a preferable embodiment of the present invention is the method for producing a roller for OA equipment according to the above embodiment, in which the rubber layer contains an organic microballoon.

Commercially available products may be used as the organic microballoons. The organic microballoons are incorporated into the rubber material in a ratio of usually 5% to 60% by volume, preferably 10% to 50% by volume, and more preferably 15% to 45% by volume. For applications in which a roller is continuously used at a high temperature for a long time, as in the case of a pressure roller, heat-resistant organic microballoons composed of an organic polymeric material having good heat resistance are preferably used. Examples of the heat-resistant organic microballoons include organic microballoons composed of a thermosetting resin such as a phenolic resin.

After the fluororesin tube is brought into close contact with the inner surface of the cylindrical mold (after the close-contact step), a primer is applied onto the inner surface of the tube to form a primer layer. The primer layer is formed in order to bond the surface layer formed of the fluororesin tube to the rubber layer. An example of the primer that can be used is a silicone adhesive which is substantially the same as an adhesive that has hitherto been used for bonding a fluororesin layer to a rubber layer.

In order to improve an adhesive force between the surface layer and the rubber layer, the inner surface of the tube is preferably subjected to a surface-roughening treatment or a defluorination treatment prior to the application of the primer. The surface-roughening treatment or the defluorination treatment can be performed by, for example, treating the inner surface of the tube with an etchant such as a Tetra-Etch solution, treating the inner surface of the tube with plasma, or etching the inner surface of the tube with laser. The adhesive force between the surface layer and the rubber layer can be improved by the surface treatment such as surface roughening, thus more reliably preventing the surface layer from separating, which may occur when the resulting roller is pulled out from the cylindrical mold (detached from the mold) or after the roller is detached from the mold. Accordingly, a preferable embodiment of the present invention is the method for producing a roller for OA equipment according to the above embodiment, in which an inner surface treatment of the fluororesin tube is performed before the primer is applied.

As the core bar, a cylinder or a column composed of a metal such as aluminum, an aluminum alloy, iron, or stainless or a ceramic such as alumina or silicon carbide having good thermal conductivity is generally used.

Next, an embodiment of the present invention will be specifically described with reference to the drawings. However, the scope of the present invention is not limited to the embodiment.

### [Cylindrical Mold and Fluororesin Tube]

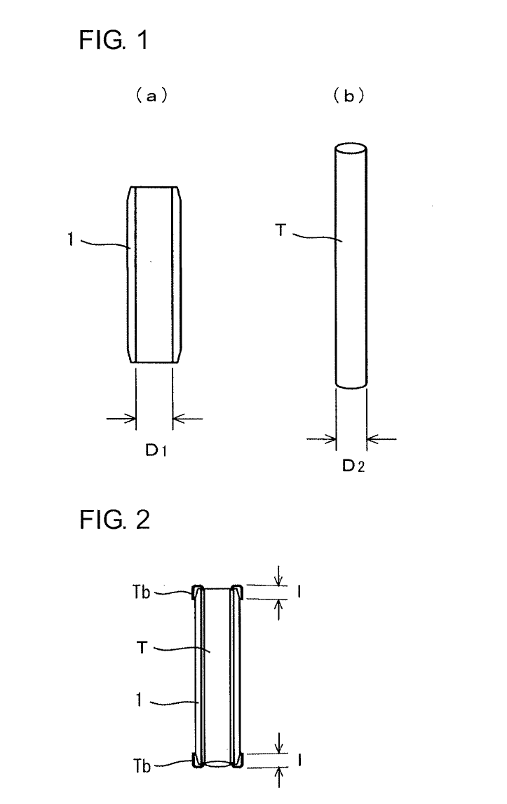

FIG. 1 includes schematic views showing a cylindrical mold and a fluororesin tube that are used in the present embodiment. Part (a) in the figure is a cross-sectional view of a cylindrical mold 1, and part (b) in the figure is a perspective view of a tube T to be inserted into the inside of the cylindrical mold. For the sake of ease of understanding, the tube T is shown in the shape when inserted in the cylindrical mold, that is, in the shape of a cylinder.

The difference between an inner diameter (mold inner diameter) D₁ of the cylindrical mold 1 and an outer diameter (tube diameter) D₂ of the tube T is 3% to 10%, and more preferably 4% to 8% of the mold inner diameter D₁. The mold inner diameter D₁ is specified by the diameter of a roller for OA equipment to be produced, and an appropriate dimension is used in accordance with the size of the roller for OA equipment, as required.

In this embodiment, a tube T longer than the cylindrical mold 1 is used as shown in FIG. 1. In the case where the tube T is longer than the cylindrical mold 1, after the tube T is inserted into the cylindrical mold 1 so that two ends of the tube T are protruded from two ends of the cylindrical mold 1, the two ends of the tube T can be turned up to the outside of the two ends of the cylindrical mold 1, as shown in FIG. 2. By this turning up, even in the case where a tube T having an outer diameter smaller than the inner diameter of the cylindrical mold 1 is used, airtightness of a gap generated between the cylindrical mold and the tube can be ensured easily and reliably. This structure is preferable because, as a result, the diameter of the tube T is reliably expanded by deaeration (vacuum suction) described below, and the tube T can be brought into close contact with the inner surface of the cylindrical mold 1.

When a length 1 of a turned-up portion T_{b} (refer to FIG. 2) is excessively short, the effect of turning up an end is not easily obtained. On the other hand, when the length 1 of the turned-up portion T_{b} is excessively long, a useless portion is generated in the tube T. Therefore, the length of the turned-up portion T_{b} is preferably 10 to 30 mm. The length of the cylindrical mold 1 is specified by the length of a rubber layer of the roller for OA equipment to be produced, and a cylindrical mold having an appropriate dimension is used in accordance with the size of the roller for OA equipment, as required.

### [Procedure for Producing Roller for OA Equipment]

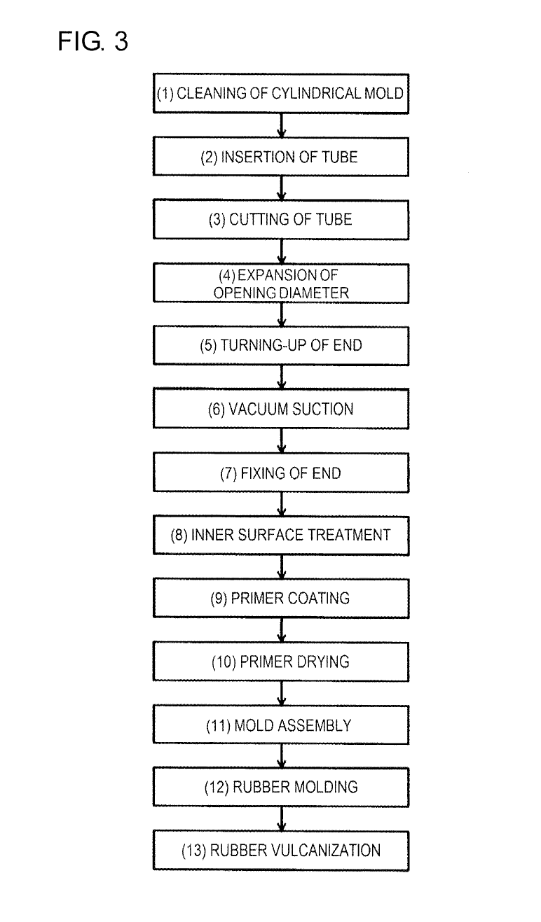

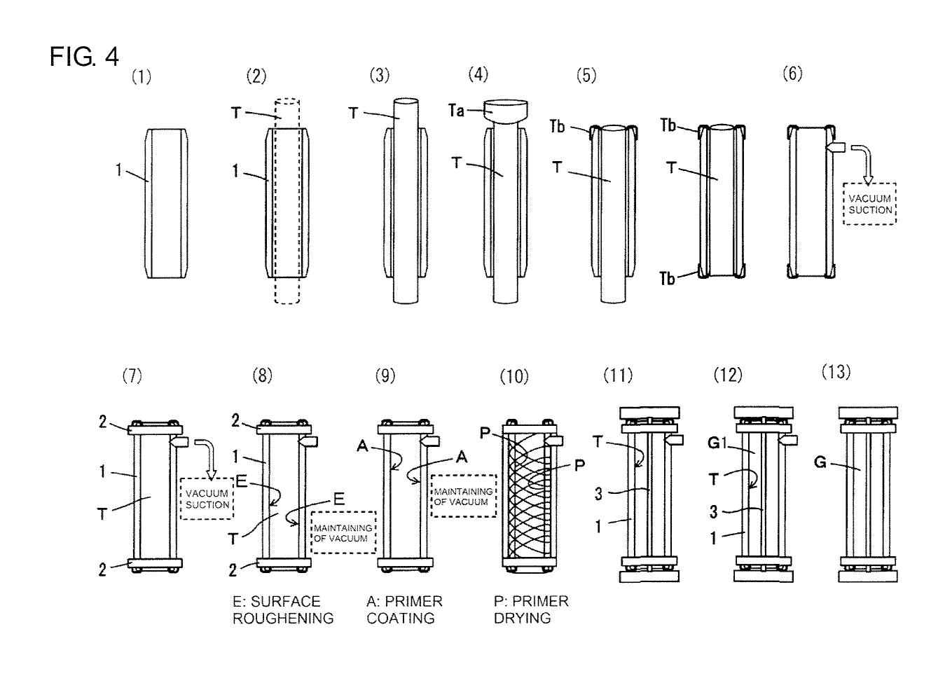

Next, the whole procedure for producing a roller for OA equipment will be described. FIG. 3 is a flowchart showing a procedure for producing a roller for OA equipment according to the present embodiment. FIG. 4 includes cross-sectional views that schematically show respective steps shown in the flowchart.

Part (1) in FIGS. 3 and 4 shows a step of cleaning a cylindrical mold and an inside thereof (cleaning of cylindrical mold). In this step, a cylindrical mold 1 having a predetermined inner diameter and a predetermined length is prepared and cleaned by air blowing to remove foreign substances adhering on a surface of the cylindrical mold 1. The cylindrical mold 1 is preferably a mold composed of a metal such as iron, stainless, or aluminum. Furthermore, in order to finish a surface of a product (roller for OA equipment) to be smooth and to improve release properties when the product is pulled out, a smoothing treatment is preferably performed on the inner surface of the cylindrical mold 1. Specifically, a surface roughness (Rz) is preferably controlled to 20 μm or less and more preferably 5 μm or less by using a drawn material in the case of aluminum or performing chromium plating, nickel plating, or the like in the case of other metals.

Part (2) shows a state in which a tube T is inserted in the cylindrical mold 1 (insertion of tube) (in FIG. 4, a part of the inserted tube T in the longitudinal direction is shown by the broken line). The thickness of the tube T is preferably in the range of 10 to 50 μm. When the thickness is within this range, sufficient flexibility and sufficient release properties can be provided to the roller for OA equipment.

A filler may be added to the tube T in accordance with the function of the roller to be produced. In the case where electrical conductivity is provided, for example, a carbon powder, a metal powder such as an Al powder, or an ion salt is added. In the case where thermal conductivity and abrasion resistance are improved, for example, a powder of SiC, TiO₂, BN, or the like is added.

Part (3) shows a state in which the tube T is cut to have a predetermined length (cutting of tube). As described in the above preferred embodiment, the tube T is cut to be longer than the length of the cylindrical mold 1, and both ends of the tube T are protruded from both ends of the cylindrical mold 1. Part (4) shows a state in which an opening diameter of an end Tₐ of the tube T is expanded (expansion of opening diameter). Part (5) shows a state in which an end of the tube T whose opening diameter is expanded is turned up to the outside of the cylindrical mold 1 (turning-up of end) (The left figure shows a state in which only one end is turned up and the right figure shows a state in which both ends are turned up). Reference character T_{b} denotes a turned-up portion.

After the two ends of the tube T are turned up to the outside of the cylindrical mold 1, a vacuum line is connected to a gap generated between the tube T and the inner surface of the cylindrical mold 1 and vacuum suction is performed. Part (6) shows a state in which the tube T is stuck fast to (brought into close contact with) the inner surface of the cylindrical mold 1 by vacuum suction (vacuum suction). Subsequently, as shown in part (7), taper jigs 2 are attached so as to fix the turned-up portions (T_{b} in FIG. 2) of the tube T and to bring the turned-up portions into close contact with the outer circumferential surface of the cylindrical mold, and vacuum suction is further performed (fixing of end).

After the ends are fixed, as shown in part (8), the inner surface of the tube T is subjected to surface roughening or defluorination while the vacuum is maintained. As described above, in order to improve the adhesive force, the inner surface of the tube is preferably roughened by etching with a Tetra-Etch solution before a primer (adhesive) is applied.

Subsequently, as shown in part (9), a primer A is applied onto the roughened inner surface of the tube T (primer coating). After the primer coating, as shown in part (10), the primer is dried (primer drying) to form a primer layer P. The primer can be dried while maintaining the vacuum state and rotating the tube T around a central axis of the cylindrical mold 1 as the center. Part (10) shows a state in which the primer is dried while the tube is rotated around the central axis of the cylindrical mold 1 as the center, and the primer layer P is formed. Preferable examples of the primer (adhesive) include X-33-174 (manufactured by Shin-Etsu Chemical Co., Ltd.), KE-1880 (manufactured by Shin-Etsu Chemical Co., Ltd.), DY39-051 (manufactured by Dow Corning Toray Co., Ltd.), PJ992CL (manufactured by Du-Pont Mitsui Co., Ltd.), and GLP103SR (manufactured by Daikin Industries, Ltd.). The thickness of the primer layer P is usually 10 μm or less.

After the formation of the primer layer P, a core bar 3 is inserted into the cylindrical mold 1 along the central axis of the cylindrical mold 1. Part (11) shows a state in which the core bar 3 is inserted (mold assembly). After the mold assembly, a material (rubber material G1) for forming a rubber layer G is injected between the tube T and the core bar 3, and the vacuum between the cylindrical mold I and the tube T is released. Part (12) shows a state in which the rubber material G1 is injected (rubber molding).

After the rubber molding, vulcanization is performed by heating the rubber material G1 at a predetermined temperature for a predetermined time to form the rubber layer G. Part (13) shows a state in which the rubber material G1 is vulcanized and the rubber layer G is formed (rubber vulcanization). Subsequently, the mold is removed, and thus a roller is obtained.

After the vulcanization (referred to as “primary vulcanization”) prior to the mold removal, vulcanization (referred to as “secondary vulcanization”) is further performed. In the case where the two vulcanization steps are performed in the cylindrical mold at one time, volatile components may remain and the vulcanization reaction may not sufficiently proceed. In contrast, in the case where vulcanization is performed in two stages, specifically, the primary vulcanization is performed in the cylindrical mold and the secondary vulcanization is then performed after the resulting roller is pulled out from the cylindrical mold (after mold removal), the remaining of the volatile components and the insufficient vulcanization reaction can be prevented.

The roller obtained as described above is subjected to finishing such as cutting of portions of respective layers close to the two ends, cleaning, etc. Subsequently, an appearance inspection of the roller is performed. A good roller for OA equipment, the roller including a surface layer having a good smoothness, can be produced by the procedure described above.

A method for producing a roller for OA equipment has been described. The present invention further provides a roller for OA equipment, the roller being produced by the method for producing a roller for OA equipment.

### EXAMPLES

The present invention will now be more specifically described using experimental examples.

### 1. Preparation of Pressure Roller

### Example 1

A pressure roller was prepared by the procedure described in the above embodiment. Specifically, first, an adhesive (manufactured by Shin-Etsu Chemical Co., Ltd.: X-33-174) for silicone rubbers was applied onto a surface of an iron core bar 3 having a diameter φ of 11 mm, and then dried at 120° C. for 15 minutes to form an adhesive layer having a thickness of 1 μm or less. Thus, a core bar was prepared.

A stainless (SUS) mold having an inner diameter φ (mold inner diameter D₁) of 18.4 mm and a length of 257 mm was used as a cylindrical mold 1, and a PFA tube having a tube thickness of 15 μm was used as a tube T. The outer diameter of the tube (tube diameter D₂) is shown in the column of “tube diameter” in Table I. The tube T was inserted into the cylindrical mold 1 and cut to have a length of 327 mm. Both ends of the tube T were turned up to the outside of the cylindrical mold 1 to each have a length of a turned-up portion of 35 mm, and a gap between the inner surface of the cylindrical mold 1 and the tube T was then vacuum-suctioned.

Next, after the inner surface of the tube T was subjected to a surface-roughening treatment, an adhesive A (manufactured by Shin-Etsu Chemical Co., Ltd.: X-33-174) for silicone rubbers was applied onto the inner surface of the tube T (flow-coating) and dried by rotation at 120° C. for 15 minutes to form a primer layer P having a thickness of 10 μm or less.

Subsequently, the core bar prepared as described above was inserted into the cylindrical mold 1 along a central axis of the cylindrical mold 1, thus performing mold assembly. A foamed silicone rubber (balloon rubber) (manufactured by Shin-Etsu Chemical Co., Ltd.: X34-2061-28L) was injected into the gap between the tube T and the core bar 3. After the injection, the temperature was increased to 160° C. and maintained for 15 minutes (including the temperature-increasing time) to perform primary vulcanization of the foamed silicone rubber (balloon rubber). Thus, a rubber layer G having a thickness of 3.5 mm was formed.

After the formation of the rubber layer G (primary vulcanization), the mold was removed. Secondary vulcanization was further performed by increasing the temperature to 250° C. and maintaining the temperature for 30 minutes (including the temperature-increasing time). Portions of the roller after the secondary vulcanization, the portions being close to both ends of the roller, were cut and the resulting roller was then cleaned. An appearance inspection of the roller was performed. Thus, a pressure roller was prepared.

### Examples 2 and 3

Pressure rollers were prepared by the same method and under the same conditions as those of Example 1 except that the tube diameters were changed as shown in Table I.

### Comparative Example

A pressure roller was prepared by the same method and under the same conditions as those of Example 1 except that the tube diameter was changed as shown in Table I.

### 2. Evaluation Methods and Evaluation Results

### (1) Evaluation Methods

The presence or absence of wrinkles on a surface layer was examined by visual observation. In addition, an image was formed by a copy machine including a pressure roller prepared above, and the quality of the image was examined.

### (2) Evaluation Results

The evaluation results of Examples 1 to 3 and Comparative Example were summarized in Table I. Table I also shows the difference (diameter difference) between the mold inner diameter D₁ and the tube diameter D₂ and a ratio (%: referred to as “diameter-difference ratio”) of the difference to the mold inner diameter D₁.

TABLE I

| | Tube | Mold inner | Tube | Diameter | Diameter- | Presence or | |
|---|---|---|---|---|---|---|---|
| | thickness | diameter | diameter | difference | difference | absence of | Quality |
| | (μm) | D₁ (mm) | D₂ (mm) | (mm) | ratio | wrinkles | of image |
| Example 1 | 15 | 18.4 | 17.1 | 1.3 | 7.1 | Absent | Good |
| Example 2 | 15 | 18.4 | 17.6 | 0.8 | 4.3 | Almost | Good |
| | | | | | | absent | |
| Example 3 | 15 | 18.4 | 17.8 | 0.6 | 3.3 | A few | Partially |
| | | | | | | | not good |
| Comparative | 15 | 18.4 | 18 | 0.4 | 2.2 | Present | Not |
| Example | | | | | | | good |

Referring to Table I, in Examples 1 to 3, in which the diameter-difference ratio (%) satisfied 3% to 10% specified in the present invention, it was found that generation of wrinkles on the surface layers of the rollers was suppressed and substantially good images were formed. In contrast, in Comparative Example, in which the diameter-difference ratio (%) was 2.2%, it was found that a large number of wrinkles were generated and a good image was not obtained.

The present invention has been described on the basis of embodiments. However, the present invention is not limited to the embodiments. Various modifications can be made to the above embodiments within the scope the same as or equivalent to that of the present invention.

### REFERENCE SIGNS LIST

1 cylindrical mold
2 taper jig
3 core bar
A adhesive
D₁ inner diameter of cylindrical mold (mold inner diameter)
D₂ outer diameter of tube (tube diameter)
G1 rubber material
G rubber layer
l length of turned-up portion
P primary layer
T tube
Tₐ end
T_{b} turned-up portion

1. A method for producing a roller for OA equipment, the roller including a core bar, a rubber layer formed on the core bar, and a fluororesin surface layer formed on the rubber layer, the method comprising:
a close-contact step of inserting a fluororesin tube into a cylindrical mold, ensuring airtightness between the tube and an inner surface of the cylindrical mold, and subsequently performing deaeration to bring the tube into close contact with the inner surface of the cylindrical mold;
a primer layer-forming step of applying a primer onto an inner surface of the tube that is brought into close contact with the inner surface of the cylindrical mold to form a primer layer; and
a rubber layer-forming step of, after the formation of the primer layer, inserting a core bar into the cylindrical mold along a central axis of the cylindrical mold, injecting a rubber material into a gap between the inserted core bar and the tube, and subsequently vulcanizing the rubber material to form a rubber layer,
wherein a difference between an inner diameter of the cylindrical mold and an outer diameter of the tube is 3% to 10% of the inner diameter of the cylindrical mold.

2. The method for producing a roller for OA equipment according to claim 1, wherein the fluororesin tube is a tube composed of a tetrafluoroethylene-perfluoroalkylvinylether resin.

3. The method for producing a roller for OA equipment according to claim 1, wherein the rubber layer contains an organic microballoon.

4. The method for producing a roller for OA equipment according to claim 1, wherein an inner surface treatment of the fluororesin tube is performed before the primer is applied.

5. A roller for OA equipment, the roller being produced by the method for producing a roller for OA equipment according to claim 1.

6. A roller for OA equipment, the roller being produced by the method for producing a roller for OA equipment according to claim 2.

7. A roller for OA equipment, the roller being produced by the method for producing a roller for OA equipment according to claim 3.

8. A roller for OA equipment, the roller being produced by the method for producing a roller for OA equipment according to claim 4.
